(19) United States
(12) Patent Application Publication
(10) Pub. No.: US 2002/0039290 A1
(43) Pub. Date: Apr. 4, 2002

(54) Sheet provided with a lighting set

(76) Inventor: Wim Lemmens, Antwerpen (BE)

Correspondence Address: BACON & THOMAS, PLLC, 4th Floor, 625 Slaters Lane, Alexandria, VA, 22314-1176, US

(21) Appl. No.: 09/825,981

(22) Filed: Apr. 5, 2001

(30) Foreign Application Priority Data
Sep. 29, 2000 (BE) 2000/0614

(51) Int. Cl. F21V 19/00

(52) U.S. Cl. 362/249; 362/382

(57) ABSTRACT

A sheet (1) is provided with a lighting set (2) which contains a plurality of holders (5) releasably fastened in a desired pattern to the sheet (1) by means of hook and loop fastening means (6), a plurality of light emission diodes (3), fitted in said holders (5) and electrical wires (9,10) connecting to said holders.

### BACKGROUND OF THE INVENTION

1. Field of the Invention

This invention relates to a sheet provided with a lighting set, such as a so-called starcloth as used in the entertainment industry, comprising a sheet which in the case of a starcloth is flexible, and a lighting set with LED's fastened to said sheet.

2. Discussion of the Related Art

Starcloths have been widely used in the entertainment industry to form backdrops or enhancing texts or graphics illustrations, on stage for example.

A starcloth is disclosed in GB 2.277.797. It comprises a sheet of flexible material carrying an array of holders connected to electrical feed wires located at the rear side of the sheet. Miniature lamps are releasably inserted in the holders to be visible through an opening in the sheet from the opposite front side. The holders are permanently secured to the sheet by means of an adhesive.

LED's have several advantages with respect to miniature filament lamps. The have a low power consumption which is less than one tenth of the traditional bulbs, and have a great brightness with wide viewing angle. Moreover they are mechanically more robust than filament bulbs and have a relatively long life span.

Although, according to GB 2.277.797, the lamps could be LED's, this is impractical. Indeed, the holders are glued to the sheet, what means that, if another pattern of lamps is desired, not only a new sheet is needed but also a new lighting set comprising holders and LED's is required.

As LED's are relatively expensive, this is a major disadvantage.

### SUMMARY OF THE INVENTION

The present invention has as an object a sheet provided with a lighting set which does not have the aforementioned disadvantages. The invention has thus for object to provide for a sheet provided with a lighting set containing a plurality of holders, a plurality of LED's fitted in the holders and wires connected to the holders, which set is reusable in another pattern on the same or another sheet.

To this aim, said holders are releasably fastened to the sheet in a desired pattern by means of hook and loop fastening means.

Such hook and loop fastening means, generally known by the trade mark Velcro®, comprise a rough layer with flexible hooks and a soft fuzzy layer with small soft loops.

One of the layers, preferably the layer with the hooks, is glued with a pressure sensitive adhesive to the holder the other layer being glued, for instance also with a pressure sensitive adhesive to the sheet.

The holder comprises preferably a central portion connected to a base, and a layer of a hook and loop fastening means is fixed to this base, either to the front side of it, around the central portion, or to the rear side of it.

The LED's are mounted in parallel on two feed wires fed with low voltage DC. The LED's have two connection pins, each connected to one of the wires.

An electrical resistance is mounted inside the holder between one of the feed wires and one connection pin of the LED.

### BRIEF DESCRIPTION OF THE DRAWINGS

To more clearly show the characteristics of the invention, a preferred embodiment is described in the following, as an example without any limitative character, with reference to the accompanying drawings, wherein:

FIG. 1 schematically shows a sheet provided with a lighting set according to the invention;

FIG. 2 represents a section according to line II-II in FIG. 1, on a larger scale;

FIG. 3 is a side view of the holder shown in FIG. 2;

FIG. 4 is a section according to line IV-IV in FIG. 3;

FIG. 5 is a perspective view of a portion of the lighting set from FIG. 1;

FIG. 6 shows a section similar to the one of FIG. 2, but wherein the holder is not shown in section and concerning a second embodiment of the invention;

FIG. 7 is a section similar to the one of FIG. 6, but concerning a third embodiment;

FIG. 8 is a section similar to the one of FIGS. 6 and 7, but concerning a fourth embodiment.

### DESCRIPTION OF PREFERRED EMBODIMENTS

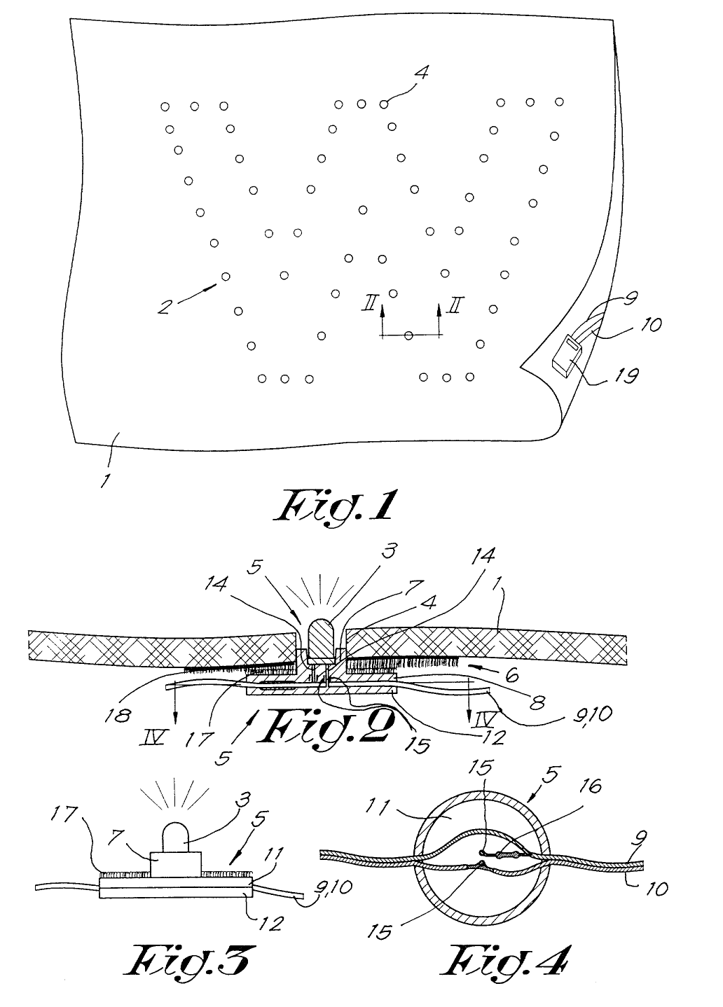

FIG. 1 shows a sheet 1 provided with a lighting set 2 containing a number of light emission diodes (LED's) 3 visible from the front side through openings 4 in the sheet 1 and disposed in a determined pattern.

The sheet 1 is a flexible sheet of any suitable material, preferably a fabric, woven or non-woven. The sheet 1 may however also be a sheet or film of plastic material.

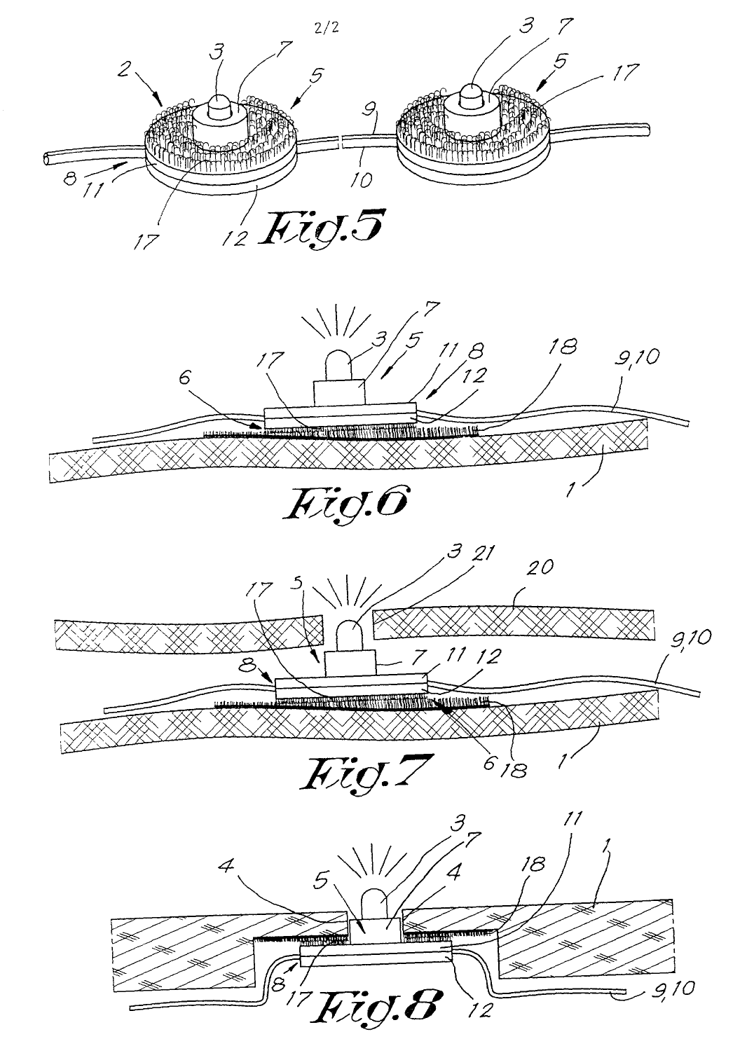

As shown in detail in FIGS. 2 to 5, each LED 3 is fitted in a holder 5 releasably fastened to the rear side of the sheet 1 by means of a hook and loop fastening means 6.

The holder 5 of molded plastics consists of a central portion 7 and a round base 8 forming an outwardly projecting annular mounting flange.

As shown in FIG. 4, the base 8 is hollow for the connections of the LED to two electrical wires 9 and 10 and consists of two portions 11 and 12 glued together at their circumference.

The front portion 11 forms one molded piece with the central portion 7 which is provided with a central cavity 13 for the LED 3.

The LED 3 has two connection pins 14 inserted through openings in the bottom of the cavity 13 and fitted in two tubular connection pieces 15 incorporated in the front portion 11 of the base 8.

One of the connection pieces 15 is soldered to the wire 9, while the other connection piece 15 is connected to the other wire 10 by the intermediary of an electrical resistance 16.

As shown in FIGS. 2, 3 and 5, the hook and loop fastening means 6 fixing a holder 5 to the rear side of the sheet 1 comprises a rough washer 17 with flexible hooks and a washer 18 with small soft loops.

The washer 17 is glued by means of pressure sensitive adhesive to the front side of the front portion 11 of the base 8, around the central portion 7 as shown in detail in FIG. 2.

The washer 18 is glued, also by means of pressure sensitive adhesive to the rear side of the sheet 1, with its central opening opposite to the opening 4 in the sheet 1 and traversed by the central portion 7 of the holder 5.

The hooks of the washer 17 hook in the loops of the washer 18.

The lighting set 2 comprises one or more strings of holders 5 forming a pre-set pattern, which are mounted in the above described way on a pair of wires 9 and 10, as shown in FIG. 4.

Each string has its own pair of wires 9 and 10. The washers 18 pertaining to different strings may have different colors.

The washers 18 may be made by punching small round from discs. The small rounds punched out, can be glued to the rear side of the base 7 of the holder 5 pertaining to the same string as the washers 18.

The strings are connected to an electronic controller 19, fixed by a hook and loop fastening means to the rear of the sheet 1. The controller assures the power supply to the LED's.

The lighting set 2 can be mounted rapidly on a sheet 1. The washers 18 are glued to the sheet 1 and the holders 5 are fastened by means of the washer 6 thereon to the washer 18. The assembly time is reduced.

Moreover the string with a pair of wires 9 and 10, holders 5 mounted on them and LED's 3 in the holders 5 may be reused time and again, on the same or another sheet 1, in the same of another pattern. If reused in another pattern or on another sheet 1, only the washers 18 have to be replaced by new ones glued to the sheet 1.

The resistance 16 inside the base 8 of each holder 5 ensures that each LED receives the same current and has the same light intensity when powered.

The holders 5 must not necessarily be fastened to the rear side of the sheet 1. FIG. 6 shows an embodiment wherein the holders 5 are each fastened by means of a hook and loop fastening means 6 with their base 8 to the front side of the sheet 1.

In this embodiment the sheet 1 has no openings 4 and the washers 17 and 18 may be discs without a central opening.

In the embodiment shown in FIG. 7, the holders 5 are fastened by means of hook and loop fastening means 6 to a sheet 1 in the same manner as shown in FIG. 6, but a second sheet 20, which is provided with an opening 21 in front of each LED 3, covers the front side of the sheet 1. The second sheet 20 may be fastened to the sheet 1, or to the holders 5 fastened to said sheet 1, by means of several hook and loop fastening means 6.

The embodiment shown in FIG. 8 differs from the embodiment of FIGS. 1 to 5 in that the sheet 1 is not a flexible fabric but a stiff panel.

Each holder 5 is releasably fastened to the rear side of the panel 1 by means of a hook and loop fastening means 6 in the same manner as described here before with respect to FIGS. 1 to 5.

To ensure that the LED's 3 are visible from the front side of the panel 1, a recess 22 has been made on the rear side of the panel 1, said recess 22 receiving the base 8 of the holder 5 so that the LED 3 projects on the front side of the panel 1 or is at least visible from the front side.

The invention is in no way limited to the above-described embodiments represented in the drawings; on the contrary, such sheet provided with a lighting set and such lighting set may be made in all sorts of variants remaining within the scope of the invention.

For instance the washer 18 of disc with loops of a hook and loop fastening means 6 may be part of the sheet 1 Itself, which can be of such fabric that it presents loops cooperating with the hooks of washers 17.

The washer or disc with the loops and the washer or disc with the hooks of a fastening means may be switched.

I claim:

1. A sheet provided with a lighting set containing:
a plurality of holders releasably fastened in a desired pattern to the sheet by means of hook and loop fastening means;
a plurality of light emission diodes, fitted in said holders; and
electrical wires connecting to said holders.

2. The sheet provided with a lighting set of claim 1, in which each hook and loop fastening means comprises a layer with hooks and a layer with loops, one of the layers being glued to the holder.

3. The sheet provided with a lighting set of claim 2 in which the layer with the hooks is fixed to the holder

4. The sheet provided with a lighting set of claim 2, in which one layer of said hook and loop fastening means is glued to the sheet.

5. The sheet provided with a lighting set of claim 2, in which said one layer of a hook and loop fastening means is part of the sheet.

6. The sheet provided with a lighting set of claim 2, in which the holder comprises a central portion connected to a base, and a layer of a hook and loop fastening means is fixed to this base.

7. The sheet provided with a lighting set of claim 1 in which the LED's are mounted in parallel on two feed wires fed with low voltage DC and have two connection pins each connected to one of the wires.

8. The sheet provided with a lighting set of claim 7, in which an electrical resistance is mounted inside the holder between one of the feed wires and one connection pin of the LED.

9. A lighting set containing a plurality of holders, a plurality of light emission diodes, fitted in said holders, electrical wires connecting to said holders, and fastening means for fastening at least a number of the holders to a sheet by means of a hook and loop connection.

10. The lighting set of claim 9, in which said fastening means comprise a layer glued to each of said holders.
